(19) United States
(12) Patent Application Publication
(10) Pub. No.: US 2026/0303471 A1
(43) Pub. Date: Oct. 1, 2026

(54) SYSTEMS AND METHODS FOR UTILIZING MACHINE LEARNING TO GENERATE NETWORK CONFIGURATIONS

(71) Applicant: Verizon Patent and Licensing Inc., Basking Ridge, NJ (US)

(72) Inventors: Sanjay Ravi VYAS, Hyderabad (IN); Mehul SHAH, Centennial, CO (US); Kishore BORRAYAGARI, Hyderabad (IN)

(73) Assignee: Verizon Patent and Licensing Inc., Basking Ridge, NJ (US)

(21) Appl. No.: 19/092,352

(22) Filed: Mar. 27, 2025

(51) Int. Cl. H04L 41/16; H04L 41/147

(52) U.S. Cl. CPC H04L 41/16; H04L 41/147

(57) ABSTRACT

A device may receive network data associated with networks, network devices, ports, bandwidth usage, and address assignments of a network architecture, and may process the network data, with one or more machine learning models, to determine network types, device types, detected ports, bandwidth, and available addresses for the network architecture. The device may generate network device configurations and network configuration changes based on the network types, the device types, the detected ports, the bandwidth, and the available addresses, and may implement the network device configurations and the network configuration changes in the network architecture. The device may update one or more of the network device configurations and one or more of the network configuration changes based on feedback. The device may analyze historical bandwidth, port performance, subnet patterns, and real-time traffic to predict and optimize network configurations, and to ensure efficient resource use, reduced errors, and adaptability to network changes.

### BACKGROUND

In the field of telecommunications, particularly in network device configuration for cellular sites, network engineers face the daunting task of manually creating intricate device configurations for a network. Even with multi-layer switches integrating Layer 2 and Layer 3 protocols, manual port and subnet reconfiguration remains challenging. The lack of real-time performance visibility further complicates decisions, highlighting the need for automated network configuration with real-time insights to improve efficiency and reduce effort.

### BRIEF DESCRIPTION OF THE DRAWINGS

FIGS. 1A-1F are diagrams of an example associated with utilizing machine learning to generate network configurations.

FIG. 2 is a diagram illustrating an example of training and using a machine learning model.

FIG. 3 is a diagram of an example environment in which systems and/or methods described herein may be implemented.

FIG. 4 is a diagram of example components of one or more devices of FIG. 3.

FIG. 5 is a flowchart of an example process for utilizing machine learning to generate network configurations.

### DETAILED DESCRIPTION OF EXAMPLE EMBODIMENTS

The following detailed description of example implementations refers to the accompanying drawings. The same reference numbers in different drawings may identify the same or similar elements.

Providing accurate device configurations is necessary for establishing robust and reliable network architectures, which are essential for services ranging from fourth generation (4G) cellular networks to fifth generation (5G) cellular networks and beyond. A network engineer may determine device configurations by first identifying appropriate device types and network types, selecting ports, defining bandwidth, and assigning Internet protocol (IP) addresses. The network engineer may then generate device configurations that are specific to needs of a network architecture based on identifying the device types and the network types, selecting the ports, defining the bandwidth, and assigning the IP addresses. However, this labor-intensive approach is fraught with challenges. For example, the network engineer must contend with a variety of issues, such as IP address conflicts, port unavailability, and dynamic bandwidth requirements that may significantly vary from one network architecture to another. Thus, current techniques for managing mobile devices consume computing resources (e.g., processing resources, memory resources, communication resources, and/or the like), networking resources, and/or other resources associated with generating erroneous device configurations, handling user complaints based on the erroneous device configurations, handling network outages due to the erroneous device configurations, correcting the network outages, and/or the like.

Some implementations described herein provide a configuration system that utilizes machine learning to predict network type and accordingly generate network configurations. For example, the configuration system may receive network data associated with networks, network devices, ports, bandwidth usage, and address assignments of a network architecture, and may process the network data, with one or more machine learning models, to determine network types, device types, detected ports, bandwidth, and available addresses for the network architecture. The configuration system may generate network device configurations and network configuration changes based on the network types, the device types, the detected ports, the bandwidth, and the available addresses, and may implement the network device configurations and the network configuration changes in the network architecture. The configuration system may receive feedback associated with implementing the network device configurations and the network configuration changes in the network architecture, and may update one or more of the network device configurations and one or more of the network configuration changes based on the feedback. Additionally, the configuration system may predict the network type by analyzing various parameters, such as location, network capacity, utilization, total customers configured, and other relevant metrics. This predictive logic enables the configuration system to dynamically classify networks (e.g., fourth generation (4G), fifth generation (5G), broadband, or fixed wireless) and optimize configurations accordingly, ensuring efficient resource allocation and improved network performance.

In this way, the configuration system utilizes machine learning to generate network configurations. For example, by employing machine learning models, the configuration system may streamline the network device configuration process. Through analysis of network data and subsequent generation of device configurations, the configuration system may optimize bandwidth utilization, improve address allocation efficiency, and ensure appropriate port assignments. The configuration system may also minimize the incidence of device configuration errors. By continuously learning from network conditions and feedback, the configuration system may dynamically adjust device configurations, thereby preemptively addressing network demands and preventing over-provisioning. The configuration system may facilitate rapid adaptation to changing network architectures, which can maintain optimal network performance and reliability and minimize the risk of network outages. Thus, the configuration system may conserve computing resources, networking resources, and/or other resources that would have otherwise been consumed by generating erroneous device configurations, handling user complaints based on the erroneous device configurations, handling network outages due to the erroneous device configurations, correcting the network outages, and/or the like.

In some implementations, the configuration system may incorporate logic for port utilization by applying multiple formulas, including calculating an average port utilization over a time period (e.g., the last seven weeks) and determining a proportional success score. For example, if a port violates a threshold in two out of seven weeks, a proportional success score may be calculated as a ratio of successful weeks to total weeks (e.g., five over seven (5/7)). A final port utilization status may be determined by combining the average utilization score with the proportional success score, enabling more accurate and efficient port assignment decisions.

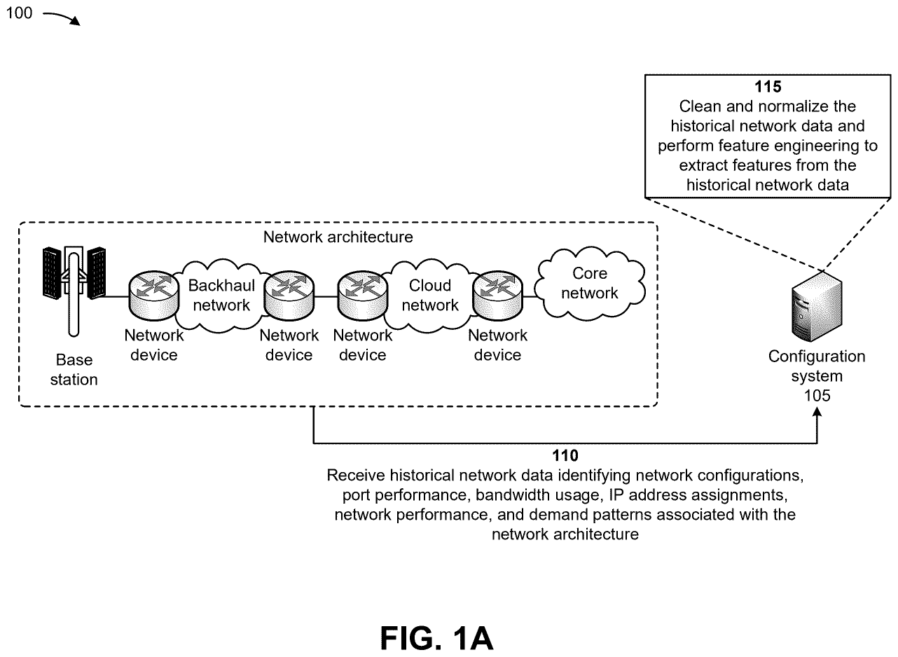

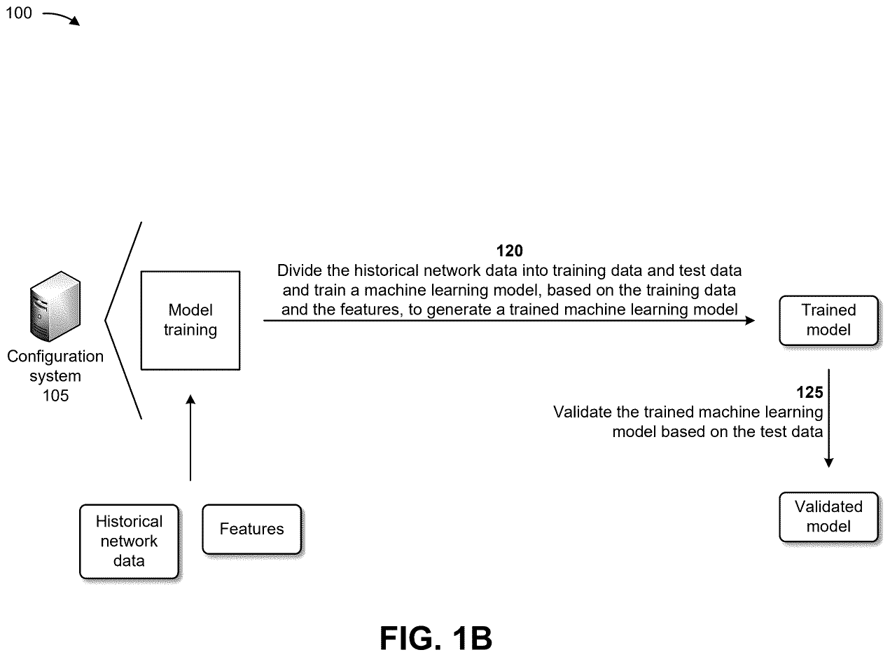

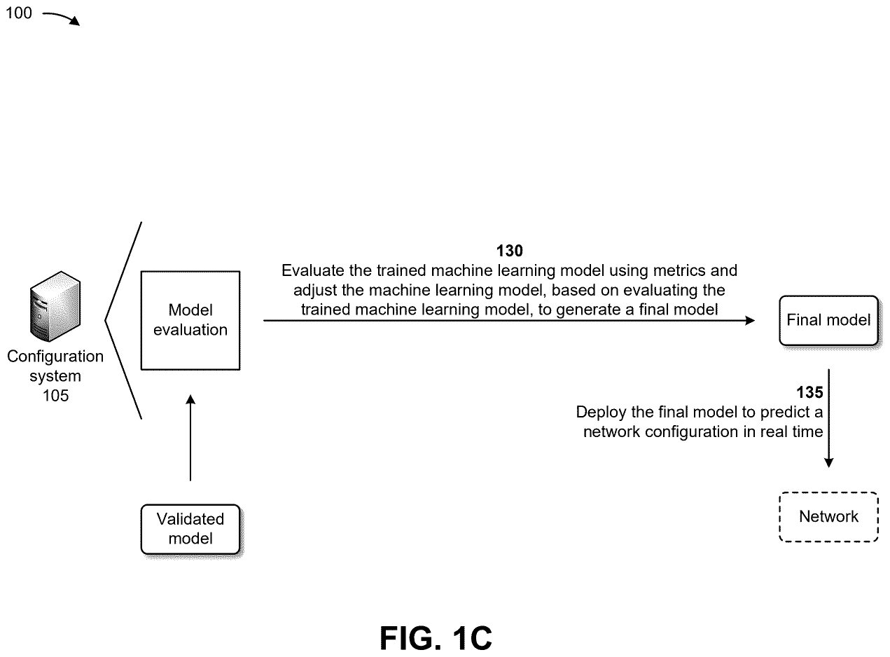

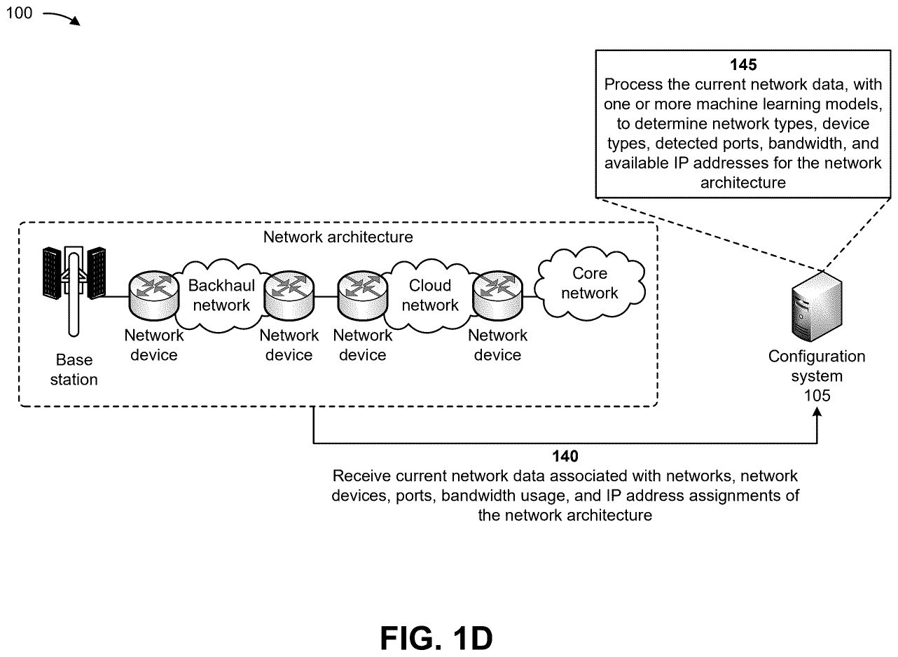

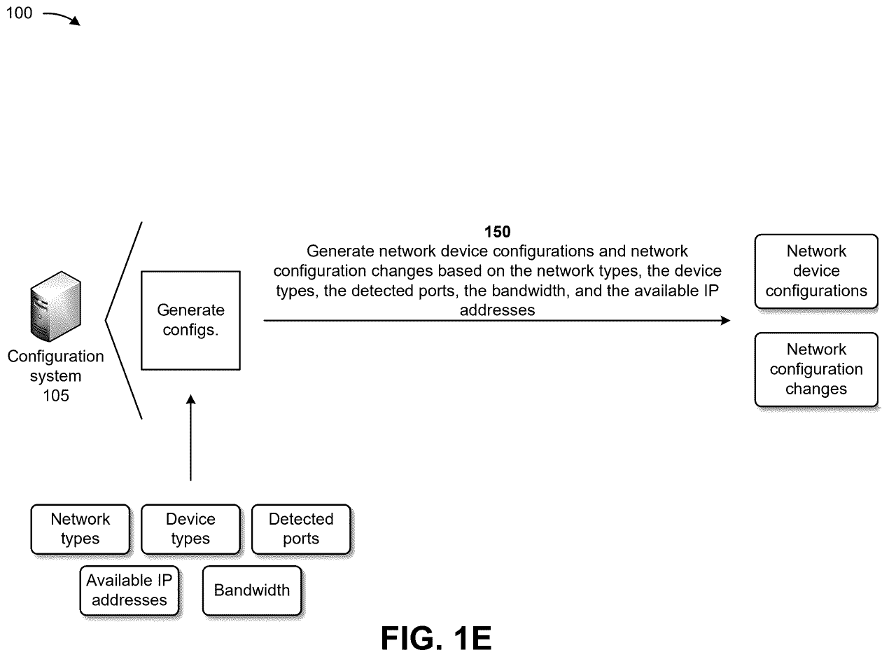

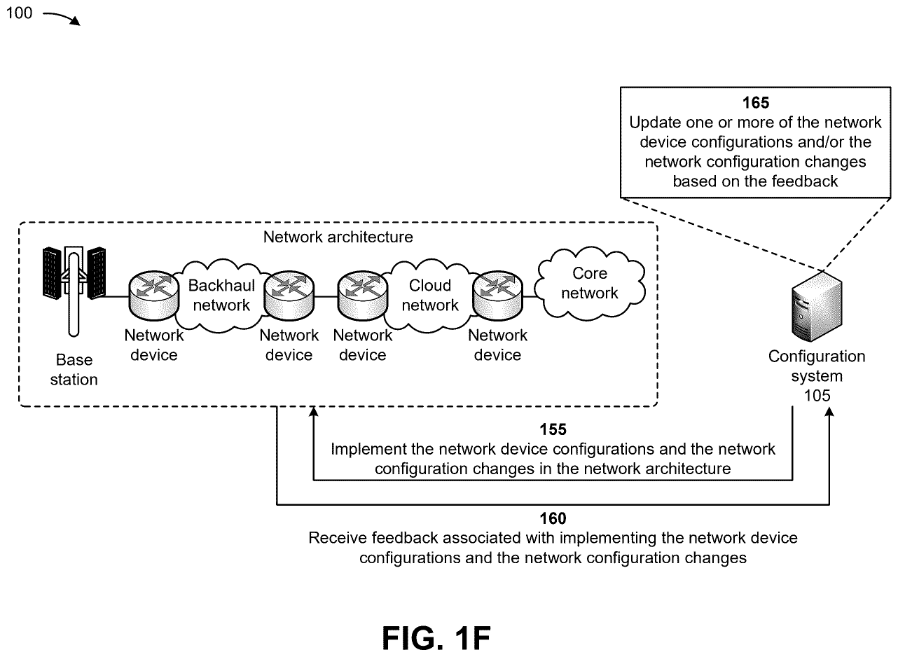

FIGS. 1A-1F are diagrams of an example 100 associated with utilizing machine learning to generate network configurations. As shown in FIGS. 1A-1F, the example 100 includes a configuration system 105 associated with a network architecture. The configuration system 105 may include a system that utilizes machine learning to generate network configurations. The network architecture may include a base station that connects to a core network via a plurality of network devices, a backhaul network, and a cloud network. Further details of the configuration system 105, the network architecture, the base station, the network devices, backhaul network, the cloud network, and the core network are provided elsewhere herein. Although implementations described herein depict a single network architecture, in some implementations, the configuration system 105 may be associated with multiple network architectures.

As shown in FIG. 1A, and by reference number 110, the configuration system 105 may receive historical network data identifying network configurations, port performance, bandwidth usage, IP address assignments, network performance, and demand patterns associated with the network architecture. For example, the configuration system 105 may receive the historical network data identifying the network configurations, the port performance, the bandwidth usage, the IP address assignments, the network performance metrics, and the demand patterns associated with the network architecture from a variety of sources. In some implementations, the configuration system 105 may receive the historical network data from a network inventory system, a network discovery system, and/or the like. Alternatively, or additionally, the configuration system 105 may receive the historical network data from various networks and network devices within the network architecture, including the backhaul network, the cloud network, the core network, the base station, backhaul network devices, cloud network devices, and core network devices. The configuration system 105 may periodically receive the historical network data from the sources, the networks, and/or the network devices, may continuously receive the historical network data from the sources, the networks, and/or the network devices, may receive the historical network data from the sources, the networks, and/or the network devices based on requesting the historical network data, and/or the like.

The historical network data may provide a comprehensive view of past network architecture behavior and may be utilized for training machine learning models to predict future network configurations and network device configurations. In some implementations, the historical network data may include current network configurations associated with the network architecture, real-time port performance metrics associated with the network architecture, live bandwidth usage statistics associated with the network architecture, IP address allocations associated with the network architecture, network performance associated with the network architecture, and ongoing demand patterns within the network architecture. For example, the configuration system 105 may continuously monitor the networks and the network devices to collect real-time data that reflects a current state of the network architecture, which may be utilized to make immediate adjustments to network configurations and network device configurations.

Additionally, the configuration system 105 may implement technical logic to predict router configurations by analyzing historical data such as media access control (MAC) address discovery patterns, interface state transitions (e.g., “learn” or “inactive”), and port utilization trends. By leveraging such data, the configuration system 105 may dynamically identify optimal routing paths, detect potential misconfigurations, and ensure efficient and secure router configurations tailored to the network's current and future demands.

The historical network data may include a collection of past data and metrics related to performance, configuration, and usage of the network architecture. For example, the historical network data may include records of past configurations of the network devices, including settings, parameters, and topology. The network configurations may include information about how network devices are connected, protocols used by the network devices, and configurations of the various network devices. The historical network data may include historical port performance data identifying performance of network ports, including metrics such as throughput, latency, error rates, and utilization. The historical network data may include bandwidth usage data identifying a quantity of bandwidth consumed over time in the network architecture, including peak usage periods, average usage, and trends in bandwidth demand. The historical network data may include IP address assignments indicating how IP addresses are allocated and used within the network architecture. The IP address assignments may include information on address ranges, subnetting, and any changes in IP address assignments over time. The historical network data may include network performance metrics identifying an overall performance of the network architecture, such as uptime, downtime, packet loss, jitter, and other quality of service (QoS) indicators. The historical network data may include demand patterns, data identifying a number of users, types of applications used, and traffic patterns. The historical network data may include inventory data about the network devices and components, including their types, models, firmware versions, and physical locations. The historical network data may include historical trends data identifying trends over time, such as growth in traffic, changes in user behavior, and evolving network architecture requirements.

As further shown by FIG. 1A, and by reference number 115, the configuration system 105 may clean and normalize the historical network data and may perform feature engineering to extract features from the historical network data. For example, the configuration system 105 may preprocess the historical network data by removing and/or normalizing any inconsistencies, duplications, or errors to ensure that the historical network data is accurate and uniform. In some implementations, the cleaning and normalization process may include techniques, such as data imputation, outlier detection, and normalization, to bring all historical network data points to a common scale. For example, the configuration system 105 may apply data imputation using techniques like k-nearest neighbors (KNN) or regression models to fill in missing values in the historical network data. Additionally, or alternatively, the configuration system 105 may preprocess the historical network data by employing advanced data cleaning techniques, such as noise reduction, data smoothing, and error correction, to improve the quality of the historical network data. For example, the configuration system 105 may use advanced anomaly detection models to identify and correct outliers in the historical network data, ensuring that the historical network data accurately represents typical network behavior.

The configuration system 105 may perform feature engineering on the historical network data (e.g., after preprocessing) to extract features from the historical network data. Feature engineering may include selecting and transforming relevant data attributes (e.g., features) that can be used to train machine learning models. Additionally, or alternatively, the feature engineering performed by the configuration system 105 may include the extraction of temporal features, such as time-of-day variations in bandwidth usage or seasonal patterns in network demand. For example, the configuration system 105 may analyze historical bandwidth usage data to identify peak usage times. In some implementations, the configuration system 105 may utilize agentic artificial intelligence to dynamically read and process network data. Agentic artificial intelligence may exhibit agency by being capable of making autonomous decisions and taking actions based on their environment, goals, and learned experiences. Agentic artificial intelligence may operate independently, adapt to new situations, and continuously learn from their interactions with the environment. By leveraging agentic artificial intelligence, the configuration system 105 may autonomously monitor network states, detect anomalies, and generate optimized configurations in real-time. This may enable the configuration system 105 to adapt to changing network conditions, predict future requirements, and ensure efficient and reliable network operations.

As shown in FIG. 1B, and by reference number 120, the configuration system 105 may divide the historical network data into training data and test data and may train a machine learning model, based on the training data and the features, to generate a trained machine learning model. For example, the configuration system 105 may split the historical network data into two subsets: one subset for training the machine learning model (e.g., the training data) and another subset for testing the machine learning model (e.g., the test data). The configuration system 105 may utilize the training data and the features to train the machine learning model by providing the machine learning model with examples from which the machine learning model can learn patterns and relationships. The features extracted from the historical network data may include variables, such as past network configurations, port performance metrics, bandwidth usage statistics, and IP address assignments. The configuration system 110 may train the machine learning model using various models, such as decision tree models, random forest models, k-nearest neighbor models, logistic regression, time series analysis, support vector machines, an/or the like.

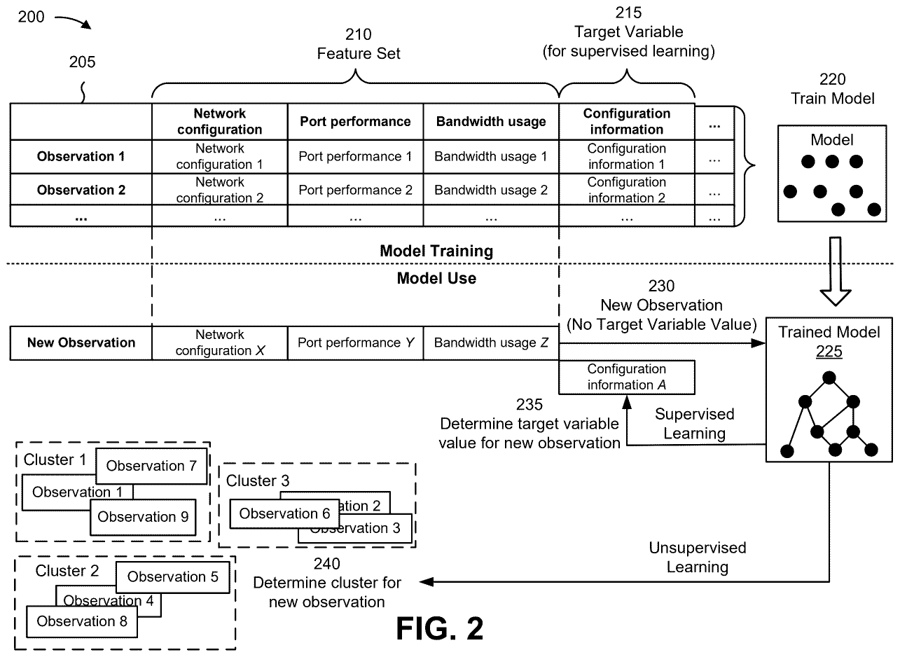

In some implementations, the configuration system 105 may utilize multiple machine learning models, and may train, validate, and evaluate the multiple machine learning models as described herein for a single machine learning model. Further details of training and using a machine learning model are also provided below in connection with FIG. 2. The multiple machine learning models may include a decision tree model, a random forest model, a k-nearest neighbors model, a logistic regression model, a time series analysis model, an autoregressive integrated moving average (ARIMA) model, a long short-term memory (LSTM) model, a graph theory model, a constraint satisfaction problem solver model, a heuristic model, a rule-based system, a support vector machine (SVM) model, and/or the like.

As further shown in FIG. 1B, and by reference number 125, the configuration system 105 may validate the trained machine learning model based on the test data. For example, the configuration system 105 may utilize the test data to evaluate the performance of the trained machine learning model by comparing predictions of the trained machine learning model to actual outcomes in the test data. The configuration system 105 may utilize validation metrics, such as accuracy, precision, recall, and an F1-score, to assess the performance of the trained machine learning model. Based on the validation results, the configuration system 105 may determine the effectiveness of the trained machine learning model in predicting network configurations and network device configurations, and may make necessary adjustments to improve the accuracy and reliability of the trained machine learning model.

As shown in FIG. 1C, and by reference number 130, the configuration system 105 may evaluate the trained machine learning model using metrics and may adjust the machine learning model, based on evaluating the trained machine learning model, to generate a final model. For example, the configuration system 105 may evaluate the trained machine learning model by comparing predictions of the trained machine learning model to actual outcomes, and using validation metrics, such as accuracy, precision, recall, and an F1-score, to assess the performance of the trained machine learning model. Based on the evaluation, the configuration system 105 may make necessary adjustments to improve the accuracy and reliability of the trained machine learning model and to generate the final model. In some implementations, the configuration system 105 may not adjust the machine learning model based on evaluating the trained machine learning model.

In some implementations, the configuration system 105 may evaluate the trained machine learning model by assessing the trained machine learning model against historical data to validate predictive capabilities of the trained machine learning model. This may include comparing predictions of the trained machine learning model with past network performance to ensure that the trained machine learning model can accurately predict future network behaviors.

Additionally, or alternatively, the configuration system 105 may evaluate the trained machine learning model by employing statistical tests, such as chi-square tests or t-tests, to compare predictions of the trained machine learning model with actual network performance data. The statistical tests may determine whether differences between predicted and actual outcomes are statistically significant.

As further shown in FIG. 1C, and by reference number 135, the configuration system 105 may deploy the final model to predict a network configuration in real time in the network architecture. For example, once the final model is generated, the configuration system 105 may utilize the final model to analyze current network data generated by the network architecture, and to provide real-time predictions for network configurations, such as determining optimal device types, port selections, bandwidth requirements, and IP address assignments. This may enable the configuration system 105 to dynamically generate and implement network configurations, ensuring efficient and reliable network architecture operations. In some implementations, the configuration system 105 may integrate the final model with a real-time analytics engine to continuously monitor and adjust network configurations determined by the final model. Additionally, or alternatively, the configuration system 105 may utilize the final model to generate predictive alerts for potential network bottlenecks or performance issues associated with the network architecture. Predictive alerts may help network administrators address issues before the issues impact network performance. Additionally, or alternatively, the configuration system 105 may incorporate the final model into an automated decision-making framework that dynamically reconfigures network devices based on predictive insights provided by the final model.

As shown by FIG. 1D, and reference number 140, the configuration system 105 may receive current network data associated with networks, network devices, ports, bandwidth usage, and IP address assignments of the network architecture. For example, the configuration system 105 may receive the current network data associated with the networks, the network devices, the ports, the bandwidth usage, and the IP address assignments of the network architecture from a variety of sources. In some implementations, the configuration system 105 may receive the current network data from a network inventory system, a network discovery system, and/or the like. Alternative, or additionally, the configuration system 105 may receive the current network data from various networks and network devices within the network architecture, including the backhaul network, the cloud network, the core network, the base station, backhaul network devices, cloud network devices, and core network devices. The configuration system 105 may periodically receive the current network data from the sources, the networks, and/or the network devices, may continuously receive the current network data from the sources, the networks, and/or the network devices, may receive the current network data from the sources, the networks, and/or the network devices based on requesting the historical network data, and/or the like.

Additionally, or alternatively, the configuration system 105 may receive the current network data from an Internet service provider (ISP) monitoring system, from network management systems (NMS) that track real-time network health and performance metrics, from a distributed network monitoring infrastructure that includes sensors and probes strategically placed within the network architecture, and/or the like.

The current network data may include records of current configurations of the network devices, including settings, parameters, and topology. The current configurations may include information about how the network devices are connected, protocols used by the network devices, and configurations of the network devices. The current network data may include port performance data identifying current performance of network ports, including metrics such as throughput, latency, error rates, and utilization. The current network data may include bandwidth usage data identifying a quantity of bandwidth currently consumed in the network architecture. The current network data may include current IP address assignments indicating how IP addresses are allocated and used within the network architecture. The IP address assignments may include information on address ranges, subnetting, and/or the like. The current network data may include network performance metrics identifying a current overall performance of the network architecture, such as uptime, downtime, packet loss, jitter, and other QoS indicators. The current network data may include current demand patterns data identifying a number of users, types of applications used, and traffic patterns. The current network data may include current inventory data about the network devices and components, including their types, models, firmware versions, and physical locations.

As further shown in FIG. 1D, and by reference number 145, the configuration system 105 may process the current network data, with one or more machine learning models, to determine network types, device types, detected ports, bandwidth, and available IP addresses for the network architecture. For example, the configuration system 105 may utilize a variety of machine learning models to analyze the current network data and to determine the network types, the device types, the detected ports, the bandwidth, and the available IP addresses for the network architecture. In some implementations, the configuration system 105 may utilize a decision tree model or a random forest model to process the current network device and to determine the network types. The decision tree model or the random forest model may classify the networks as a hub site, a medium site, a macro site, an inbuild site, a small site, a donor site, a fourth generation (4G) network, a fifth generation (5G) network, a broadband network, a fixed wireless network, and/or the like based on features such as a number of connected cell sites, traffic patterns, network topology, and redundancy requirements.

In some implementations, the configuration system 105 may utilize a decision tree model or a random forest model to process the current network device and to determine the device types. The decision tree model or the random forest model may classify the network devices as a hub, a standalone, or a spoke based on features such as a number of connected cell sites, traffic patterns, network topology, and redundancy requirements.

In some implementations, the configuration system 105 may utilize a k-nearest neighbors model and logistic regression to process the current network device and to determine the detected ports. The k-nearest neighbors model and the logistic regression may identify the best available ports by analyzing inventory data, historical trends, current port availability, and performance metrics. In some implementations, the configuration system 105 may calculate metrics for the detected ports, such as port availability, port performance latency, port packet drop rate, and port utilization. Additionally, the configuration system 105 may calculate the best available port status by analyzing a time period (e.g., the last seven weeks) of data and applying a formula to compute the average score for each port, thereby determining its availability status. The configuration system 105 may utilize the metrics to generate scores for the detected ports, and may rank the detected ports based on the scores. The best available ports may then be identified based on the rankings of the detected ports.

In some implementations, the configuration system 105 may utilize an ARIMA model or an LSTM model to process the current network device and to determine the bandwidth requirements. The ARIMA model or the LSTM model may predict future bandwidth requirements based on historical usage data, demand planning inputs, peak usage patterns, and expected growth. In some implementations, the ARIMA model or the LSTM model may determine the bandwidth requirements based on a configured bandwidth of the network architecture, a bandwidth capacity of the network architecture, a bandwidth utilization in the network architecture, alarms and/or tickets generated based on bandwidth issues, packet drops caused by bandwidth issues, a quantity of customers connected to the network architecture, and/or the like. Additionally, the configuration system 105 may incorporate logic for alarms by applying a mixed formula that considers an average score of alarms over a time period (e.g., the last seven weeks) and a proportion of alarm occurrences relative to the total calculated weeks. This combined approach may enable more accurate predictions and adjustments to bandwidth requirements.

In some implementations, the configuration system 105 may utilize a constraint satisfaction problem solver or a heuristic model to process the current network device and to determine the available IP addresses. The constraint satisfaction problem solver or the heuristic model may assign IP addresses to the available IP addresses based on avoiding IP address conflicts, ensuring availability, and adhering to network segmentation and security policies. In some implementations, the configuration system 105 may utilize the constraint satisfaction problem solver or the heuristic model to process the current network device and to determine subnet assignments in the network architecture. The constraint satisfaction problem solver or the heuristic model may assign the subnets based on avoiding subnet conflicts, ensuring availability, and adhering to network segmentation and security policies.

As shown by FIG. 1E, and reference number 150, the configuration system 105 may generate network device configurations and network configuration changes based on the network types, the device types, the detected ports, the bandwidth, and the available IP addresses. For example, the configuration system 105 may utilize a rule-based system or a support vector machine model to process the network types, the device types, the detected ports, the bandwidth, and the available IP addresses, and to generate network device configurations and network configuration changes that ensure compliance with network standards. Additionally, or alternatively, the configuration system 105 may utilize a reinforcement learning model to continuously improve the network device configurations and the network configuration changes based on feedback and real-time performance metrics. This may enable adaptive learning and optimization over time. Additionally, or alternatively, the configuration system 105 may utilize a decision tree model, a random forest model, a k-nearest neighbors model, or a logistic regression model to determine the network device configurations and the network configuration changes based on the network types, the device types, the detected ports, the bandwidth, and the available IP addresses.

As shown by FIG. 1F, and reference number 155, the configuration system 105 may implement the network device configurations and the network configuration changes in the network architecture. For example, the configuration system 105 may implement the network device configurations and the network configuration changes in the network architecture by causing the network devices to utilize the network device configurations and by causing other network resources to implement the network configuration changes. In some implementations, the configuration system 105 may implement the network device configurations and the network configuration changes in the network architecture by creating circuits for the network devices, assigning subnets and IP addresses, ensuring that the network device configurations and the network configuration changes are compatible with the network architecture, establishing secure communication links between the network devices, configuring routing protocols, validating IP address assignments against network policies, and/or the like. In some implementations, the configuration system 105 may monitor the network device configurations and the network configuration changes within the network architecture to ensure proper functionality and performance. This may involve continuous monitoring of network performance metrics and prompt identification of any discrepancies or issues.

As further shown by FIG. 1F, and reference number 160, the configuration system 105 may receive feedback associated with implementing the network device configurations and the network configuration changes. For example, the configuration system 105 may collect feedback from network monitoring systems, network performance metrics, and user reports to assess the effectiveness of the implemented network device configurations and network configuration changes. The feedback may include network performance data, device functionality data, data identifying any issues encountered during implementation, detailed metrics on throughput, latency, packet loss, and error rates, and/or the like.

As further shown by FIG. 1F, and reference number 165, the configuration system 105 may update one or more of the network device configurations and/or one or more of the network configuration changes based on the feedback. For example, the configuration system 105 may analyze the feedback to identify issues, may adjust the machine learning models if necessary, and may generate updated network device configurations and/or updated network configuration changes that address any identified issues. The configuration system 105 may implement the updated network device configurations and the updated network configuration changes in the network architecture, as described above in connection with reference number 155.

This iterative process may ensure that the network configurations remain optimal and responsive to changing network conditions and requirements. In some implementations, updating the network device configurations and/or the network configuration changes may include reconfiguring network paths, reallocating bandwidth, and modifying network device roles based on real-time network performance data. These updates may ensure that the network architecture remains efficient and capable of handling current demands. Additionally, or alternatively, the configuration system 105 may utilize machine-learning-driven anomaly detection mechanisms to identify and rectify configuration issues promptly, ensuring network stability and reliability. These mechanisms can detect and address potential issues before they impact network performance. Additionally, or alternatively, the configuration system 105 may utilize time series analysis models to forecast bandwidth requirements and adjust network configurations accordingly. This approach can help in anticipating future network demands and ensuring that the configurations are scalable and efficient. Furthermore, the configuration system 105 may identify the next available IP address by categorizing a subnet pool based on location, network type, and available virtual local area network (VLAN), by validating against the network data, and by ensuring that they are unique in nature without any duplication within the same network. The configuration system 105 may also generate and predict always-available IP addresses and VLANs to proactively avoid outages and maintain seamless network operations.

In this way, the configuration system 105 utilizes machine learning to generate network configurations. For example, by employing machine learning models, the configuration system 105 may streamline the network device configuration process. Through analysis of network data and subsequent generation of device configurations, the configuration system 105 may optimize bandwidth utilization, improve address allocation efficiency, and ensure appropriate port assignments. The configuration system 105 may also minimize the incidence of device configuration errors. By continuously learning from network conditions and feedback, the configuration system 105 may dynamically adjust device configurations, thereby preemptively addressing network demands and preventing over-provisioning. The configuration system 105 may facilitate rapid adaptation to changing network architectures, which can maintain optimal network performance and reliability and minimize the risk of network outages. Thus, the configuration system 105 may conserve computing resources, networking resources, and/or other resources that would have otherwise been consumed by generating erroneous device configurations, handling user complaints based on the erroneous device configurations, handling network outages due to the erroneous device configurations, correcting the network outages, and/or the like.

As indicated above, FIGS. 1A-1F are provided as an example. Other examples may differ from what is described with regard to FIGS. 1A-1F. The number and arrangement of devices shown in FIGS. 1A-1F are provided as an example. In practice, there may be additional devices, fewer devices, different devices, or differently arranged devices than those shown in FIGS. 1A-1F. Furthermore, two or more devices shown in FIGS. 1A-1F may be implemented within a single device, or a single device shown in FIGS. 1A-1F may be implemented as multiple, distributed devices. Additionally, or alternatively, a set of devices (e.g., one or more devices) shown in FIGS. 1A-1F may perform one or more functions described as being performed by another set of devices shown in FIGS. 1A-1F.

FIG. 2 is a diagram illustrating an example 200 of training and using a machine learning model. The machine learning model training and usage described herein may be performed using a machine learning system. The machine learning system may include or may be included in a computing device, a server, a cloud computing environment, and/or the like, such as the configuration system 105 described in more detail elsewhere herein.

As shown by reference number 205, a machine learning model may be trained using a set of observations. The set of observations may be obtained from historical data, such as data gathered during one or more processes described herein. In some implementations, the machine learning system may receive the set of observations (e.g., as input) from the configuration system 105, as described elsewhere herein.

As shown by reference number 210, the set of observations includes a feature set. The feature set may include a set of variables, and a variable may be referred to as a feature. A specific observation may include a set of variable values (or feature values) corresponding to the set of variables. In some implementations, the machine learning system may determine variables for a set of observations and/or variable values for a specific observation based on input received from the configuration system 105. For example, the machine learning system may identify a feature set (e.g., one or more features and/or feature values) by extracting the feature set from structured data, by performing natural language processing to extract the feature set from unstructured data, by receiving input from an operator, and/or the like.

As an example, a feature set for a set of observations may include a first feature of network configuration, a second feature of port performance, a third feature of bandwidth usage, and so on. As shown, for a first observation, the first feature may have a value of network configuration 1, the second feature may have a value of port performance 1, the third feature may have a value of bandwidth usage 1, and so on. These features and feature values are provided as examples and may differ in other examples.

As shown by reference number 215, the set of observations may be associated with a target variable. The target variable may represent a variable having a numeric value, may represent a variable having a numeric value that falls within a range of values or has some discrete possible values, may represent a variable that is selectable from one of multiple options (e.g., one of multiple classes, classifications, labels, and/or the like), may represent a variable having a Boolean value, and/or the like. A target variable may be associated with a target variable value, and a target variable value may be specific to an observation. In example 200, the target variable may be entitled “configuration information” and may include a value of configuration information 1 for the first observation.

The target variable may represent a value that a machine learning model is being trained to predict, and the feature set may represent the variables that are input to a trained machine learning model to predict a value for the target variable. The set of observations may include target variable values so that the machine learning model can be trained to recognize patterns in the feature set that lead to a target variable value. A machine learning model that is trained to predict a target variable value may be referred to as a supervised learning model.

In some implementations, the machine learning model may be trained on a set of observations that do not include a target variable. This may be referred to as an unsupervised learning model. In this case, the machine learning model may learn patterns from the set of observations without labeling or supervision, and may provide output that indicates such patterns, such as by using clustering and/or association to identify related groups of items within the set of observations.

As shown by reference number 220, the machine learning system may train a machine learning model using the set of observations and using one or more machine learning algorithms, such as a regression algorithm, a decision tree algorithm, a neural network algorithm, a k-nearest neighbor algorithm, a support vector machine algorithm, and/or the like. After training, the machine learning system may store the machine learning model as a trained machine learning model 225 to be used to analyze new observations.

As shown by reference number 230, the machine learning system may apply the trained machine learning model 225 to a new observation, such as by receiving a new observation and inputting the new observation to the trained machine learning model 225. As shown, the new observation may include a first feature of network configuration X, a second feature of port performance Y, a third feature of bandwidth usage Z, and so on, as an example. The machine learning system may apply the trained machine learning model 225 to the new observation to generate an output (e.g., a result). The type of output may depend on the type of machine learning model and/or the type of machine learning task being performed. For example, the output may include a predicted value of a target variable, such as when supervised learning is employed. Additionally, or alternatively, the output may include information that identifies a cluster to which the new observation belongs, information that indicates a degree of similarity between the new observation and one or more other observations, and/or the like, such as when unsupervised learning is employed.

As an example, the trained machine learning model 225 may predict a value of configuration information A for the target variable of the configuration information for the new observation, as shown by reference number 235. Based on this prediction, the machine learning system may provide a first recommendation, may provide output for determination of a first recommendation, may perform a first automated action, may cause a first automated action to be performed (e.g., by instructing another device to perform the automated action), and/or the like.

In some implementations, the trained machine learning model 225 may classify (e.g., cluster) the new observation in a cluster, as shown by reference number 240. The observations within a cluster may have a threshold degree of similarity. As an example, if the machine learning system classifies the new observation in a first cluster (e.g., a network configuration cluster), then the machine learning system may provide a first recommendation. Additionally, or alternatively, the machine learning system may perform a first automated action and/or may cause a first automated action to be performed (e.g., by instructing another device to perform the automated action) based on classifying the new observation in the first cluster.

As another example, if the machine learning system were to classify the new observation in a second cluster (e.g., a port performance cluster), then the machine learning system may provide a second (e.g., different) recommendation and/or may perform or cause performance of a second (e.g., different) automated action.

In some implementations, the recommendation and/or the automated action associated with the new observation may be based on a target variable value having a particular label (e.g., classification, categorization, and/or the like), may be based on whether a target variable value satisfies one or more thresholds (e.g., whether the target variable value is greater than a threshold, is less than a threshold, is equal to a threshold, falls within a range of threshold values, and/or the like), may be based on a cluster in which the new observation is classified, and/or the like.

In this way, the machine learning system may apply a rigorous and automated process to generate network configuration information. The machine learning system enables recognition and/or identification of tens, hundreds, thousands, or millions of features and/or feature values for tens, hundreds, thousands, or millions of observations, thereby increasing accuracy and consistency and reducing delay associated with generating network configuration information relative to requiring computing resources to be allocated for tens, hundreds, or thousands of operators to manually generate network configuration information.

As indicated above, FIG. 2 is provided as an example. Other examples may differ from what is described in connection with FIG. 2.

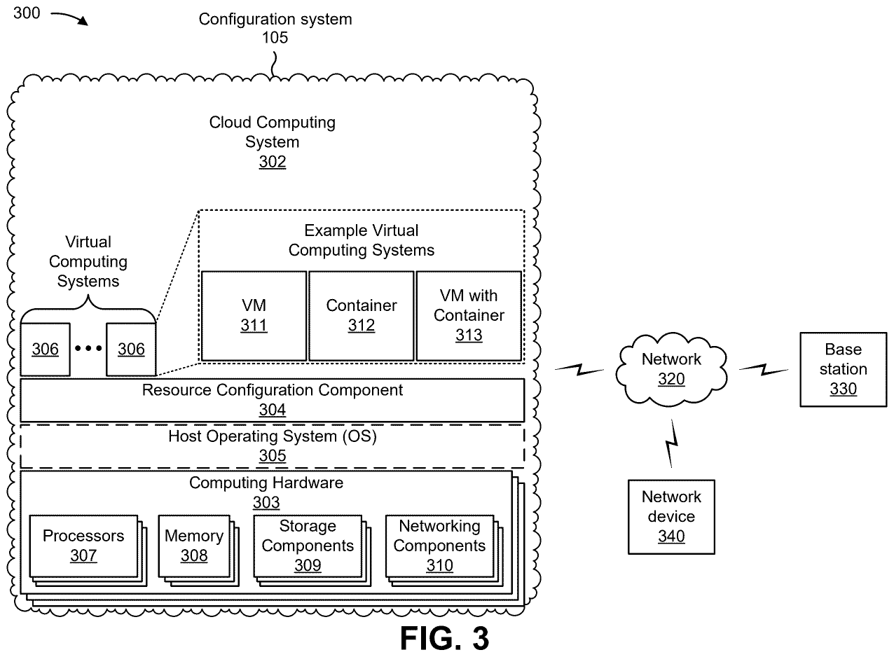

FIG. 3 is a diagram of an example environment 300 in which systems and/or methods described herein may be implemented. As shown in FIG. 3, the environment 300 may include the configuration system 105, which may include one or more elements of and/or may execute within a cloud computing system 302. The cloud computing system 302 may include one or more elements 303-313, as described in more detail below. As further shown in FIG. 3, the environment 300 may include a network 320, a base station 330, and/or a network device 340. Devices and/or elements of the environment 300 may interconnect via wired connections and/or wireless connections.

The cloud computing system 302 includes computing hardware 303, a resource management component 304, a host operating system (OS) 305, and/or one or more virtual computing systems 306. The cloud computing system 302 may execute on, for example, an Amazon Web Services platform, a Microsoft Azure platform, or a Snowflake platform. The resource management component 304 may perform virtualization (e.g., abstraction) of the computing hardware 303 to create the one or more virtual computing systems 306. Using virtualization, the resource management component 304 enables a single computing device (e.g., a computer or a server) to operate like multiple computing devices, such as by creating multiple isolated virtual computing systems 306 from the computing hardware 303 of the single computing device. In this way, the computing hardware 303 can operate more efficiently, with lower power consumption, higher reliability, higher availability, higher utilization, greater flexibility, and lower cost than using separate computing devices.

The computing hardware 303 includes hardware and corresponding resources from one or more computing devices. For example, the computing hardware 303 may include hardware from a single computing device (e.g., a single server) or from multiple computing devices (e.g., multiple servers), such as multiple computing devices in one or more data centers. As shown, the computing hardware 303 may include one or more processors 307, one or more memories 308, one or more storage components 309, and/or one or more networking components 310. Examples of a processor, a memory, a storage component, and a networking component (e.g., a communication component) are described elsewhere herein.

The resource management component 304 includes a virtualization application (e.g., executing on hardware, such as the computing hardware 303) capable of virtualizing computing hardware 303 to start, stop, and/or manage one or more virtual computing systems 306. For example, the resource management component 304 may include a hypervisor (e.g., a bare-metal or Type 1 hypervisor, a hosted or Type 2 hypervisor, or another type of hypervisor) or a virtual machine monitor, such as when the virtual computing systems 306 are virtual machines 311. Additionally, or alternatively, the resource management component 304 may include a container manager, such as when the virtual computing systems 306 are containers 312. In some implementations, the resource management component 304 executes within and/or in coordination with a host operating system 305.

A virtual computing system 306 includes a virtual environment that enables cloud-based execution of operations and/or processes described herein using the computing hardware 303. As shown, the virtual computing system 306 may include a virtual machine 311, a container 312, or a hybrid environment 313 that includes a virtual machine and a container, among other examples. The virtual computing system 306 may execute one or more applications using a file system that includes binary files, software libraries, and/or other resources required to execute applications on a guest operating system (e.g., within the virtual computing system 306) or the host operating system 305.

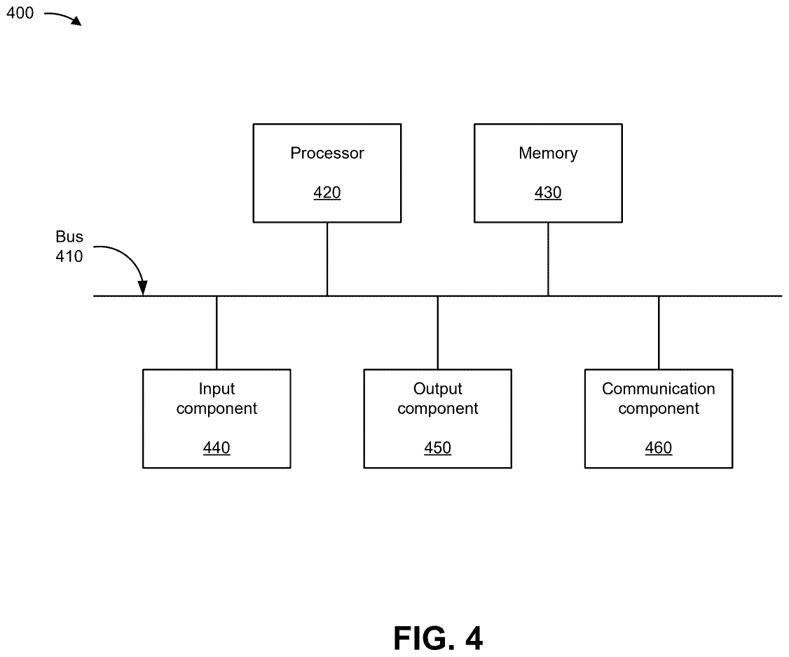

Although the configuration system 105 may include one or more elements 303-313 of the cloud computing system 302, may execute within the cloud computing system 302, and/or may be hosted within the cloud computing system 302, in some implementations, the configuration system 105 may not be cloud-based (e.g., may be implemented outside of a cloud computing system) or may be partially cloud-based. For example, the configuration system 105 may include one or more devices that are not part of the cloud computing system 302, such as a device 400 of FIG. 4, which may include a standalone server or another type of computing device. The configuration system 105 may perform one or more operations and/or processes described in more detail elsewhere herein.

The network 320 includes one or more wired and/or wireless networks. For example, the network 320 may include a cellular network, a public land mobile network (PLMN), a local area network (LAN), a wide area network (WAN), a private network, the Internet, and/or a combination of these or other types of networks. The network 320 enables communication among the devices of the environment 300.

In some implementations, the network 320 may include a backhaul network, a cloud network, and/or a core network. The backhaul network may include a segment of a telecommunications network that connects the core network to the smaller subnetworks at an edge of the network, such as access points, base stations, or cell towers. The backhaul network may serve as an intermediate link that aggregates and transmits data between edge devices and a central network infrastructure. The backhaul network may utilize various transmission technologies, including fiber optics, microwave, and satellite, to ensure high-capacity, reliable communication and support the overall performance and scalability of the network.

The cloud network may include a type of network infrastructure that leverages cloud computing technologies to provide scalable, on-demand access to computing resources and services over the Internet. The cloud network may enable delivery of various information technology (IT) resources, such as servers, storage, databases, networking, software, and analytics, through a cloud service provider's data centers. The cloud network may provide flexibility, cost-efficiency, and ease of management.

The core network may include an example functional architecture in which systems and/or methods described herein may be implemented. For example, the core network may include an example architecture of a fifth generation (5G) next generation (NG) core network included in a 5G wireless telecommunications system. In some implementations, the core network may be implemented as a reference-point architecture, a fourth generation (4G) core network, a sixth generation (6G) core network, among other examples. The core network may include a number of functional elements. The functional elements may include, for example, a network slice selection function (NSSF), a network exposure function (NEF), an authentication server function (AUSF), a unified data management (UDM) component, a policy control function (PCF), an application function (AF), an access and mobility management function (AMF), and/or a session management function (SMF), a user plane function (UPF). These functional elements may be communicatively connected via a message bus. Each of the functional elements may be implemented on one or more devices associated with a wireless telecommunications system. In some implementations, one or more of the functional elements may be implemented on physical devices, such as an access point, a base station, and/or a gateway. In some implementations, one or more of the functional elements may be implemented on a computing device of a cloud computing environment.

The base station 330 may support, for example, a cellular radio access technology (RAT). The base station 330 may include one or more base stations (e.g., base transceiver stations, radio base stations, node Bs, eNodeBs (eNBs), gNodeBs (gNBs), base station subsystems, cellular sites, cellular towers, access points, transmit receive points (TRPs), radio access nodes, macrocell base stations, microcell base stations, picocell base stations, femtocell base stations, or similar types of devices) and other network entities that can support wireless communication for a user equipment (UE). The base station 330 may transfer traffic between the UE (e.g., using a cellular RAT), one or more base stations (e.g., using a wireless interface or a backhaul interface, such as a wired backhaul interface), and/or the core network. The base station 330 may provide one or more cells that cover geographic areas.

In some implementations, the base station 330 may perform scheduling and/or resource management for the UE covered by the base station 330 (e.g., the UE covered by a cell provided by the base station 330). In some implementations, the base station 330 may be controlled or coordinated by a network controller, which may perform load balancing, network-level configuration, and/or other operations. The network controller may communicate with the base station 330 via a wireless or wireline backhaul. In some implementations, the base station 330 may include a network controller, a self-organizing network (SON) module or component, or a similar module or component. In other words, the base station 330 may perform network control, scheduling, and/or network management functions (e.g., for uplink, downlink, and/or sidelink communications covered by the base station 330).

The network device 340 may include one or more devices capable of receiving, processing, storing, routing, and/or providing traffic (e.g., a packet and/or other information or metadata) in a manner described herein. For example, the network device 340 may include a router, such as a label switching router (LSR), a label edge router (LER), an ingress router, an egress router, a provider router (e.g., a provider edge router or a provider core router), a virtual router, or another type of router. Additionally, or alternatively, the network device 340 may include a gateway, a switch, a firewall, a hub, a bridge, a reverse proxy, a server (e.g., a proxy server, a cloud server, or a data center server), a load balancer, and/or a similar device. In some implementations, the network device 340 may be a physical device implemented within a housing, such as a chassis. In some implementations, the network device 340 may be a virtual device implemented by one or more computing devices of a cloud computing environment or a data center. In some implementations, a group of network devices 340 may be a group of data center nodes that are used to route traffic flow through a network. Additionally, the network device 340 may support advanced features such as dynamic routing protocols (e.g., OSPF and BGP), VLAN tagging, quality of service (QoS) prioritization, and network address translation (NAT). The network device 340 may also include capabilities for monitoring and analyzing traffic patterns, detecting anomalies, and implementing security measures to ensure robust and secure network operations.

The number and arrangement of devices and networks shown in FIG. 3 are provided as an example. In practice, there may be additional devices and/or networks, fewer devices and/or networks, different devices and/or networks, or differently arranged devices and/or networks than those shown in FIG. 3. Furthermore, two or more devices shown in FIG. 3 may be implemented within a single device, or a single device shown in FIG. 3 may be implemented as multiple, distributed devices. Additionally, or alternatively, a set of devices (e.g., one or more devices) of the environment 300 may perform one or more functions described as being performed by another set of devices of the environment 300.

FIG. 4 is a diagram of example components of a device 400, which may correspond to the configuration system 105, the base station 330, and/or the network device 340. In some implementations, the configuration system 105, the base station 330, and/or the network device 340 may include one or more devices 400 and/or one or more components of the device 400. As shown in FIG. 4, the device 400 may include a bus 410, a processor 420, a memory 430, an input component 440, an output component 450, and a communication component 460.

The bus 410 includes one or more components that enable wired and/or wireless communication among the components of the device 400. The bus 410 may couple together two or more components of FIG. 4, such as via operative coupling, communicative coupling, electronic coupling, and/or electric coupling. The processor 420 includes a central processing unit, a graphics processing unit, a microprocessor, a controller, a microcontroller, a digital signal processor, a field-programmable gate array, an application-specific integrated circuit, and/or another type of processing component. The processor 420 is implemented in hardware, firmware, or a combination of hardware and software. In some implementations, the processor 420 includes one or more processors capable of being programmed to perform one or more operations or processes described elsewhere herein.

The memory 430 includes volatile and/or nonvolatile memory. For example, the memory 430 may include random access memory (RAM), read only memory (ROM), a hard disk drive, and/or another type of memory (e.g., a flash memory, a magnetic memory, and/or an optical memory). The memory 430 may include internal memory (e.g., RAM, ROM, or a hard disk drive) and/or removable memory (e.g., removable via a universal serial bus connection). The memory 430 may be a non-transitory computer-readable medium. The memory 430 stores information, instructions, and/or software (e.g., one or more software applications) related to the operation of the device 400. In some implementations, the memory 430 includes one or more memories that are coupled to one or more processors (e.g., the processor 420), such as via the bus 410.

The input component 440 enables the device 400 to receive input, such as user input and/or sensed input. For example, the input component 440 may include a touch screen, a keyboard, a keypad, a mouse, a button, a microphone, a switch, a sensor, a global positioning system sensor, an accelerometer, a gyroscope, and/or an actuator. The output component 450 enables the device 400 to provide output, such as via a display, a speaker, and/or a light-emitting diode. The communication component 460 enables the device 400 to communicate with other devices via a wired connection and/or a wireless connection. For example, the communication component 460 may include a receiver, a transmitter, a transceiver, a modem, a network interface card, and/or an antenna.

The device 400 may perform one or more operations or processes described herein. For example, a non-transitory computer-readable medium (e.g., the memory 430) may store a set of instructions (e.g., one or more instructions or code) for execution by the processor 420. The processor 420 may execute the set of instructions to perform one or more operations or processes described herein. In some implementations, execution of the set of instructions, by one or more processors 420, causes the one or more processors 420 and/or the device 400 to perform one or more operations or processes described herein. In some implementations, hardwired circuitry may be used instead of or in combination with the instructions to perform one or more operations or processes described herein. Additionally, or alternatively, the processor 420 may be configured to perform one or more operations or processes described herein. Thus, implementations described herein are not limited to any specific combination of hardware circuitry and software.

The number and arrangement of components shown in FIG. 4 are provided as an example. The device 400 may include additional components, fewer components, different components, or differently arranged components than those shown in FIG. 4. Additionally, or alternatively, a set of components (e.g., one or more components) of the device 400 may perform one or more functions described as being performed by another set of components of the device 400.

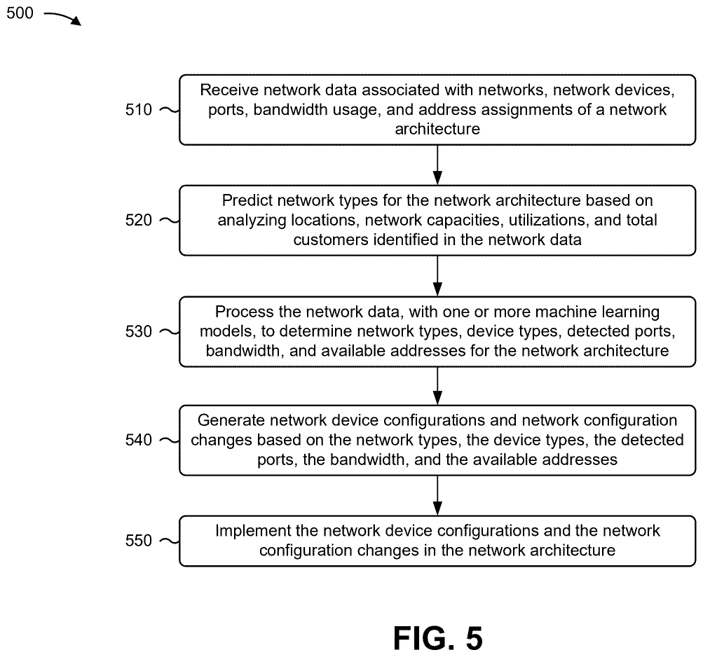

FIG. 5 depicts a flowchart of an example process 500 for utilizing machine learning to generate network configurations. In some implementations, one or more process blocks of FIG. 5 may be performed by a device (e.g., the configuration system 105). In some implementations, one or more process blocks of FIG. 5 may be performed by another device or a group of devices separate from or including the device. Additionally, or alternatively, one or more process blocks of FIG. 5 may be performed by one or more components of the device 400, such as the processor 420, the memory 430, the input component 440, the output component 450, and/or the communication component 460.

As shown in FIG. 5, process 500 may include receiving network data associated with networks, network devices, ports, bandwidth usage, and address assignments of a network architecture (block 510). For example, the device may receive network data associated with networks, network devices, ports, bandwidth usage, and address assignments of a network architecture, as described above.

As further shown in FIG. 5, process 500 may include predicting network types for the network architecture based on analyzing locations, network capacities, utilizations, and total customers identified in the network data (block 520). For example, the device may predict network types for the network architecture based on analyzing locations, network capacities, utilizations, and total customers identified in the network data, as described above.

As further shown in FIG. 5, process 500 may include processing the network data, with one or more machine learning models, to determine network types, device types, detected ports, bandwidth, and available addresses for the network architecture (block 530). For example, the device may process the network data, with one or more machine learning models, to determine network types, device types, detected ports, bandwidth, and available addresses for the network architecture, as described above. In some implementations, the one or more machine learning models include one or more of a decision tree model, a random forest model, a k-nearest neighbors model, a logistic regression model, a time series analysis model, an autoregressive integrated moving average model, a long short-term memory model, a graph theory model, a constraint satisfaction problem solver model, a heuristic model, a rule-based system, or a support vector machine (SVM) model.

In some implementations, processing the network data, with the one or more machine learning models, to determine the device types includes analyzing features of the network devices, wherein the features include connected cell sites, traffic patterns, network topology, and redundancy requirements associated with the network devices, and determining the device types based on analyzing the features of the network devices. In some implementations, processing the network data, with the one or more machine learning models, to determine the detected ports includes analyzing features of the ports, wherein the features include inventory data, historical trends, current port availability, and performance metrics associated with the ports, and determining the detected ports based on analyzing the features of the ports. In some implementations, processing the network data, with the one or more machine learning models, to determine the bandwidth includes analyzing features of the bandwidth usage, wherein the features include historical usage data, demand planning inputs, peak usage patterns, and expected growth associated with the bandwidth usage, and determining the bandwidth based on analyzing the features of the bandwidth usage.

As further shown in FIG. 5, process 500 may include generating network device configurations and network configuration changes based on the network types, the device types, the detected ports, the bandwidth, and the available addresses (block 540). For example, the device may generate network device configurations and network configuration changes based on the network types, the device types, the detected ports, the bandwidth, and the available addresses, as described above.

As further shown in FIG. 5, process 500 may include implementing the network device configurations and the network configuration changes in the network architecture (block 550). For example, the device may implement the network device configurations and the network configuration changes in the network architecture, as described above. In some implementations, implementing the network device configurations and the network configuration changes in the network architecture includes creating circuits for the network devices in the network architecture. In some implementations, implementing the network device configurations and the network configuration changes in the network architecture includes assigning subnets and addresses to the network devices in the network architecture.

In some implementations, process 500 includes receiving feedback associated with implementing the network device configurations and the network configuration changes in the network architecture, and updating one or more of the network device configurations and one or more of the network configuration changes based on the feedback and to generate one or more updated network device configurations and one or more updated network configuration changes. In some implementations, process 500 includes implementing the one or more updated network device configurations and the one or more updated network configuration changes in the network architecture.

In some implementations, process 500 includes receiving historical network data identifying historical network configurations, historical port performance, historical bandwidth usage, historical address assignments, historical network performance, and historical demand patterns associated with the network architecture; preprocessing the historical network data, extracting features from the historical network data; dividing the historical network data into training data and test data; training a machine learning model, selected from the one or more machine learning models, based on the training data and the features and to generate a trained machine learning model; and validating the trained machine learning model based on the test data. In some implementations, process 500 includes evaluating the trained machine learning model using metrics, and adjusting the machine learning model, based on evaluating the trained machine learning model, to generate a final model. In some implementations, preprocessing the historical network data includes cleaning and normalizing the historical network data. In some implementations, extracting the features from the historical network data includes performing feature engineering to extract the features from the historical network data.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code-it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

As used herein, “selectively” performing an operation means to either perform the operation or refrain from performing the operation. For example, selectively performing an operation based on whether a condition is satisfied means that the operation is performed if the condition is satisfied and that the operation is not performed if the condition is not satisfied (or vice versa). Thus, selectively performing an operation may include determining whether to perform the operation and then either performing the operation or refraining from performing the operation based on that determination.

As used herein, “selectively” performing a first operation or a second operation means to perform either the first operation or the second operation. For example, selectively performing a first operation or a second operation based on whether a condition is satisfied means that the first operation is performed if the condition is satisfied and that the second operation is performed if the condition is not satisfied (or vice versa). Thus, selectively performing a first operation or a second operation may include determining whether to perform either the first operation or the second operation and then performing either the first operation or the second operation based on that determination.

To the extent the aforementioned implementations collect, store, or employ personal information of individuals, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various encryption and anonymization techniques for particularly sensitive information.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method, comprising:
receiving, by a device, network data associated with networks, network devices, ports, bandwidth usage, and address assignments of a network architecture;
predicting, by the device, network types for the network architecture based on analyzing locations, network capacities, utilizations, and total customers identified in the network data;
processing, by the device, the network data, with one or more machine learning models, to determine device types, detected ports, bandwidth, and available addresses for the network architecture;
generating, by the device, network device configurations and network configuration changes based on the network types, the device types, the detected ports, the bandwidth, and the available addresses; and
implementing, by the device, the network device configurations and the network configuration changes in the network architecture.

2. The method of claim 1, further comprising:
receiving feedback associated with implementing the network device configurations and the network configuration changes in the network architecture; and
updating one or more of the network device configurations and one or more of the network configuration changes based on the feedback and to generate one or more updated network device configurations and one or more updated network configuration changes.

3. The method of claim 2, further comprising:
implementing the one or more updated network device configurations and the one or more updated network configuration changes in the network architecture.

4. The method of claim 1, further comprising:
receiving historical network data identifying historical network configurations, historical port performance, historical bandwidth usage, historical address assignments, historical network performance, and historical demand patterns associated with the network architecture;
preprocessing the historical network data;
extracting features from the historical network data;
dividing the historical network data into training data and test data;
training a machine learning model, selected from the one or more machine learning models, based on the training data and the features and to generate a trained machine learning model; and
validating the trained machine learning model based on the test data.

5. The method of claim 4, further comprising:
evaluating the trained machine learning model using metrics; and
adjusting the machine learning model, based on evaluating the trained machine learning model, to generate a final model.

6. The method of claim 4, wherein preprocessing the historical network data comprises:
cleaning and normalizing the historical network data.

7. The method of claim 4, wherein extracting the features from the historical network data comprises:
performing feature engineering to extract the features from the historical network data.

8. A device, comprising:
one or more processors configured to:
receive network data associated with networks, network devices, ports, bandwidth usage, and address assignments of a network architecture;
predict network types for the network architecture based on analyzing locations, network capacities, utilizations, and total customers identified in the network data;
process the network data, with one or more machine learning models, to determine device types, detected ports, bandwidth, and available addresses for the network architecture;
generate network device configurations and network configuration changes based on the network types, the device types, the detected ports, the bandwidth, and the available addresses;
implement the network device configurations and the network configuration changes in the network architecture;
receive feedback associated with implementing the network device configurations and the network configuration changes in the network architecture; and
update one or more of the network device configurations and one or more of the network configuration changes based on the feedback and to generate one or more updated network device configurations and one or more updated network configuration changes.

9. The device of claim 8, wherein the one or more machine learning models include one or more of a decision tree model, a random forest model, a k-nearest neighbors model, a logistic regression model, a time series analysis model, an autoregressive integrated moving average model, a long short-term memory model, a graph theory model, a constraint satisfaction problem solver model, a heuristic model, a rule-based system, or a support vector machine model.

10. The device of claim 8, wherein the one or more processors, to process the network data, with the one or more machine learning models, to determine the device types, are configured to:
analyze features of the network devices,
wherein the features include connected cell sites, traffic patterns, network topology, and
redundancy requirements associated with the network devices; and
determine the device types based on analyzing the features of the network devices.

11. The device of claim 8, wherein the one or more processors, to process the network data, with the one or more machine learning models, to determine the detected ports, are configured to:
analyze features of the ports,
wherein the features include inventory data, historical trends, current port availability,
and performance metrics associated with the ports; and
determine the detected ports based on analyzing the features of the ports.

12. The device of claim 8, wherein the one or more processors, to process the network data, with the one or more machine learning models, to determine the bandwidth, are configured to:
analyze features of the bandwidth usage,
wherein the features include historical usage data, demand planning inputs, peak usage
patterns, and expected growth associated with the bandwidth usage; and
determine the bandwidth based on analyzing the features of the bandwidth usage.

13. The device of claim 8, wherein the one or more processors, to implement the network device configurations and the network configuration changes in the network architecture, are configured to:
create circuits for the network devices in the network architecture.

14. The device of claim 8, wherein the one or more processors, to implement the network device configurations and the network configuration changes in the network architecture, are configured to:
assign subnets and addresses to the network devices in the network architecture.

15. A non-transitory computer-readable medium storing a set of instructions, the set of instructions comprising:
one or more instructions that, when executed by one or more processors of a device, cause the device to:
receive network data associated with networks, network devices, ports, bandwidth usage, and address assignments of a network architecture;
predict network types for the network architecture based on analyzing locations, network capacities, utilizations, and total customers identified in the network data;
process the network data, with one or more machine learning models, to determine device types, detected ports, bandwidth, and available addresses for the network architecture,
wherein the one or more machine learning models include one or more of a decision tree model, a random forest model, a k-nearest neighbors model, a logistic regression model, a time series analysis model, an autoregressive integrated moving average model, a long short-term memory model, a graph theory model, a constraint satisfaction problem solver model, a heuristic model, a rule-based system, or a support vector machine model;
generate network device configurations and network configuration changes based on the network types, the device types, the detected ports, the bandwidth, and the available addresses; and
implement the network device configurations and the network configuration changes in the network architecture.

16. The non-transitory computer-readable medium of claim 15, wherein the one or more instructions further cause the device to:
receive feedback associated with implementing the network device configurations and the network configuration changes in the network architecture;
update one or more of the network device configurations and one or more of the network configuration changes based on the feedback and to generate one or more updated network device configurations and one or more updated network configuration changes; and
implement the one or more updated network device configurations and the one or more updated network configuration changes in the network architecture.

17. The non-transitory computer-readable medium of claim 15, wherein the one or more instructions further cause the device to:
receive historical network data identifying historical network configurations, historical port performance, historical bandwidth usage, historical address assignments, historical network performance, and historical demand patterns associated with the network architecture;
preprocess the historical network data;
extract features from the historical network data;
divide the historical network data into training data and test data;
train a machine learning model, selected from the one or more machine learning models, based on the training data and the features and to generate a trained machine learning model; and
validate the trained machine learning model based on the test data.

18. The non-transitory computer-readable medium of claim 17, wherein the one or more instructions further cause the device to:
evaluate the trained machine learning model using metrics; and
adjust the machine learning model, based on evaluating the trained machine learning model, to generate a final model.

19. The non-transitory computer-readable medium of claim 15, wherein the one or more instructions, that cause the device to process the network data, with the one or more machine learning models, to determine the device types, cause the device to:
analyze features of the network devices,
wherein the features include connected cell sites, traffic patterns, network topology, and redundancy requirements associated with the network devices; and
determine the device types based on analyzing the features of the network devices.

20. The non-transitory computer-readable medium of claim 15, wherein the one or more instructions, that cause the device to process the network data, with the one or more machine learning models, to determine the detected ports, cause the device to:
analyze features of the ports,
wherein the features include inventory data, historical trends, current port availability,
and performance metrics associated with the ports; and
determine the detected ports based on analyzing the features of the ports.
